(19) United States
(12) Patent Application Publication
(10) Pub. No.: US 2007/0222240 A1
(43) Pub. Date: Sep. 27, 2007

(54) Pet waste collector

(76) Inventor: Gary Sherman, Brooklyn, NY (US)

Correspondence Address: Law Firm of Y. Kateshov, 174 Ferndale Road, SCARSDALE, NY, 10583, US

(21) Appl. No.: 11/389,862

(22) Filed: Mar. 27, 2006

(51) Int. Cl. A01K 29/00

(52) U.S. Cl. 294/1.5

(57) ABSTRACT

A portable collector for pet's waste is configured with a frame displaceable between a folded position and an operative position, in which the waste is collected.

### BACKGROUND OF THE INVENTION

1. Field of the Invention

The invention relates to a portable device for collecting the pet's waste.

2. Prior Art Discussion

It is well known that pet owners are obligated by law to clean up after their pets. However, droppings can be consistently spotted everywhere. One of the reasons that may explain the persistence of this problem is an inconvenient and sometime complex structure of at least some of the known devices designed to pick up droppings. A further reason is the prohibitive cost of other known devices of this type.

U.S. Patent Application No. 20040201232 discloses attaching a bag to a looped frame before using it as a dog waste device. Replacing bags may be inconvenient for a pet owner.

U.S. Patent Application No.

20020140240 discloses a portable pet excrement collector configured with a pair of bag frame pivoting arms, a rotational stop associated with each of the pivoting arms, and an attaching pivot element frame the arms. The pivot element is sized and shaped to permit the frame pivoting arms to pivot so as to open and close the bags. The collector has a structure that is not easily manufactured and, as a consequence, may be cost-ineffective.

A need, therefore, exists for a dog waste collector that is simple in use.

A further need exists for a dog waste collector that is cost-effective.

Still a further need exists for a dog waste collector that has a light portable structure.

### SUMMARY OF THE INVENTION

The above-mentioned needs are met by a portable waste collector configured according to the invention. The collector includes a flexible frame manufactured with a bag for collecting pet's waste and a rod detachably coupled to the frame.

In accordance with one aspect of the invention, a flexible frame is made from wire or plastic having two predetermined positions: a folded position and an operative position. In the folded position the frame is relatively small and can be easily stored or carried. In the operative position, the frame is relatively large and configured to collect a waste before it hits the ground.

In a further aspect of the invention, a flexible frame made from shape memory material can be transformed from one of folded and operative positions to the other and back to the initial position. An insignificant force applied by a pet owner to the frame in the operative position after droppings have been collected brings the frame in the folded position in which the collected droppings are secured within a folded bag. Similarly, an insignificant force applied to the frame in the folded position drives the frame and bag to the operative position.

A further aspect of the invention is concerned with a rod detachably coupled to the frame. Preferably, the rod may have a telescopic structure adjusting the length of the rod to provide a comfort to a pet owner operating the inventive collector.

In accordance with still a further aspect of the invention, a method of operating the inventive waste collector is implemented by bringing the waste collector to an operative position in which it collects a pet's waste. Subsequently, the waste collector is folded to assume a folded position for further discarding.

### BRIEF DESCRIPTION OF THE DRAWINGS

The above and other features will become more readily apparent from the following description better understood in conjunction with the accompanying drawings, in which:

FIG. 1 is a perspective view of the inventive waste collector;

FIG. 2 is a cross-sectional view of a frame associated with the inventive waste collector and shown in an operating position;

FIG. 3 is a cross-sectional view of the frame of FIG. 2 shown in a folded position;

FIG. 4 is a cross-sectional view of a V-shaped frame shown in an operative position;

FIG. 5 is a cross-sectional view of the V-shape of FIG. 4 in a folded position;

FIG. 6 is a cross-sectional view of a frame configured in accordance with another embodiment of the invention;

FIG. 7 is a frame segment having weakened regions;

FIG. 8 is a cross-sectional view of a coupling element configured in accordance with one embodiment of the invention and operable to couple a rod and a frame of the waste collector of FIG. 1; and

FIG. 9 is a cross-sectional view of a coupling element configured in accordance with another embodiment of the invention and operable to couple a rod and a frame of the waste collector of FIG. 1.

FIGS. 10-12 are cross-sectional views of a bayonet connection between a rod and a frame.

### SPECIFIC DESCRIPTION

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. The words “connect,” “couple,” and similar terms do not necessarily denote direct and immediate connections, but also include connections through intermediate elements or devices.

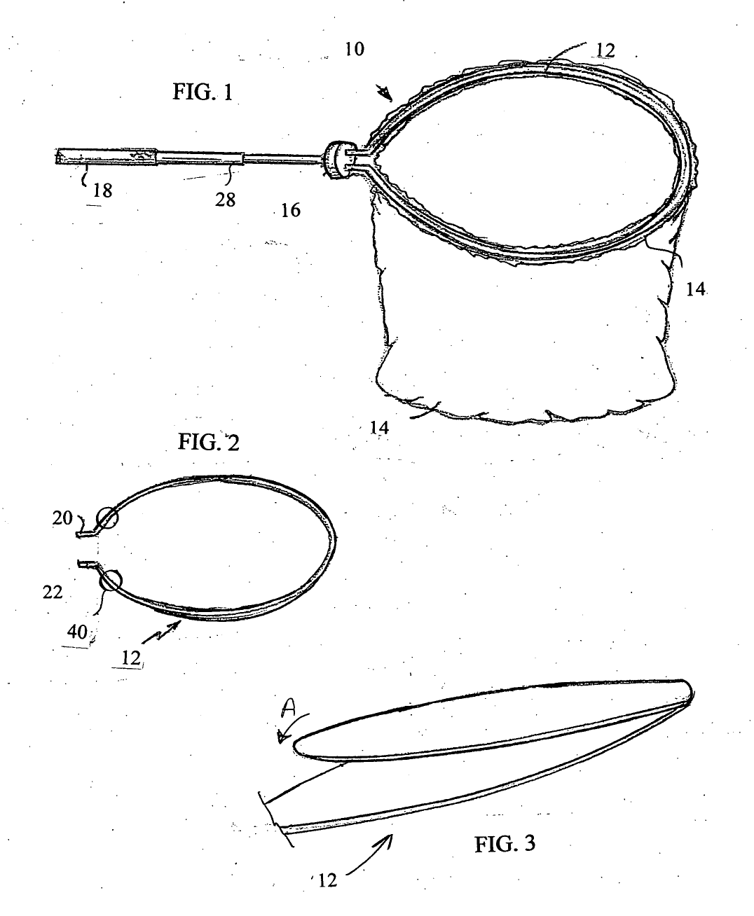

Referring to FIG. 1, a disposable pet waste collector 10 is configured with a bag 14 coupled to a frame 12 and a handle 18. The handle 18 is detachably coupled to frame 12. In use, the inventive waste collector 10 can be placed under the anus of a pet during defecation which relieves a pet owner from having to pickup the fecal material after the fact. Preferably, handle 18 has a telescopic structure.

The frame 12 may be made from regular plastic and/or steel. Packaged in a paper or plastic envelope (not shown) or held by any restricting element, such as a rubber end, frame 12 is stored in the folded position. When released, frame 12 voluntarily unfolds from a compact, folded position, as shown in FIG. 3, to assume the operative position (FIG. 2). The frame 12 has a generally elliptical cross-section and is preferably made from wire. A shaped wire may have various polygonally- and circularly-shaped cross-sections as well as a V-shapes cross-section. During the use of collector 10, frame 12 transforms from the folded position to the operative position. After the waste has been collected, frame 12 along with bag 14 is disposed.

In accordance with a further embodiment, frame 12 may be made from memory shape materials characterized by two states or positions: the folded position, in which, as shown in FIG. 3, waste collector 10 can be easily stored or carried, and an operative position, in which, as illustrated in FIG. 2, the collector is used for the intended purposes. Shape memory materials that may be used for manufacturing wire include, but not limited to, metallic compounds and biodegradable shape memory polymeric materials well known to those of ordinary skill in the art of “smart” materials.

The frame 12 preferably has a discontinuous periphery, as shown in FIGS. 2 and 3, and generally assumes a U-shaped cross-section in the operative position thereof. During manufacturing, frame 12 made from regular wire may be reduced in size by twirling into an 8-shaped configuration and, then folded into two ring-shaped elements as indicated by an arrow A in FIG. 3. In the final, folded position of frame 12, both ring-shaped elements lie substantially flat against one another assuming, thus, a shape of a relatively small circle. Subsequently, folded frame 12 is put into an envelope (not shown) or any other easily removable constraining element preventing the frame's voluntary opening. Dimensions and shapes of frame 12 may be selected during manufacturing based on the size of pet. Preferably, however, frame 12 is uniformly dimensioned.

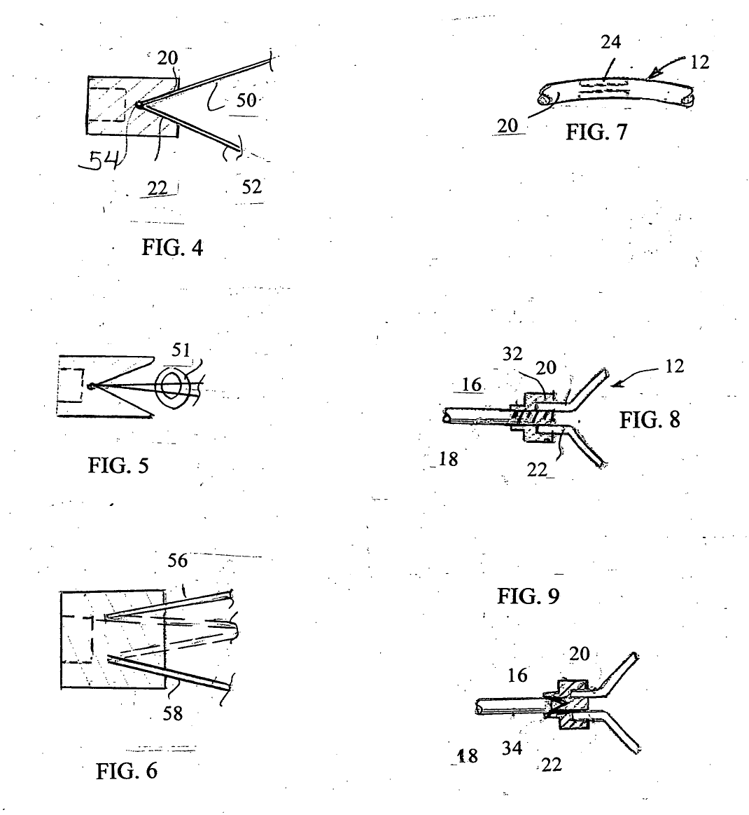

FIGS. 4 and 5 illustrate a further embodiment of frame 12. In the operative position, two arms 50 and 52 assume a V-shape configuration. A spring element 54 is coupled to ends 20 and 22 of arms 50 and 52, respectively, and is configured to displace the arms to the operative position of frame 12 from the initial, folded position of frame 12, as shown in FIG. 5, in which arms 50 and 52 may be kept in place by a removable holder 51. Alternatively, both folded and operative positions may be established automatically if arms 20 and 22 are made from shape memory materials. The bag 14 (not shown) follows arms 50 and 52 between the initial and operative positions.

The holder 51 shown in FIG. 5 can secure arms 52, 50 in the folded position. Once holder 51 is removed, the arms spring out to the operative position. The holder 51 may be any resilient element preventing voluntary displacement of arms 52 and 50 to the operative position.

FIG. 6 illustrates a further modification of frame 12. Similarly to FIGS. 4 and 5, frame 12 assumes a V shape in the operative position. However, the proximal ends of arms 56 and 58 are spaced apart. Applying an insignificant force to arms 56 and 58 by the dog owner will be sufficient to displace the arms to a folded position in which the distal ends of the arms are close to one another, as shown in phantom lines. Reversing the direction in which a force is applied, the arms may be brought to the operative position, as shown in FIG. 6. Depending on material, the arms can move voluntarily to the operative position without applying a force.

As shown in FIG. 7, frame 12 may have weakened regions 24 formed along frame 12 between its opposite body ends 20, 22. The weakened regions 24 may have a diameter smaller than the rest of body 20. In accordance with this embodiment, the pet owner may apply an insignificant force sufficient to transform frame 12 from the operative position of FIG. 2 to the folded position after the waste has been collected. In order to transform frame 12 to the folded position, the pet owner may also apply an insignificant force to the frame which will fold in two halves along weakened regions 24 and close bag 14.

Returning to FIG. 1, bag 14 is made from plastic, paper or fabric and may have numerous shapes and sizes. Numerous techniques can be used to couple bag 14 to frame 12 as is readily apparent to those of ordinary skill in the art. For example, the upper edge of bag 14 may be folded over frame 12 and connected to the wall of the bag. If bag 14 is made from paper, the upper edge may be glued. The bag may be pre-folded to be substantially flat (not shown) in the folded position of frame 12 and, as frame 12 is brought to the operative position, the bag opens up to assume a form shown in FIG. 1. If a plastic bag is used, its upper edge may be soldered or glued to the rest of the bag. The upper edge may be sawn to the rest of bag 14 if fabric is used. Preferably, frame 12 and bag 14 are manufactured as a unit. However, any bag, for example, a shopping bag, can be used in conjunction with frame 12 which, in this case, would be manufactured as a separate component. Attachment of the bag to frame 12, if these elements are separately manufactured, may be realized by various means, such as paper clips coupling the upper edge of the bag to the frame.

The handle 18, preferably, but nor necessarily, has a telescopic configuration and is made from light metal or plastic and preferably covered by light reflecting paint or layer 28 (FIG. 1). Pets are often walked during late hours and the visibility of handle 18 increases safety of both the owner and pet.

Coupling of handle 18 to the frame/bag assembly is realized by a connecting element 16 (FIGS. 1 and 8-12). The connecting element 16 that may have different configurations can be either fixed to frame 12 or to handle 18.

Referring to FIGS. 8 and 9, connecting element 16 has two spaced throughgoing passages 32 configured to receive respective ends 20, 22 of frame 12. If connecting element 16 is fixed to handle 18, passages 32 are so shaped and dimensioned that a pet owner can easily insert ends 20, 22 in the respective passages, thereby, engaging the frame and coupling element together. After waste collector 10 has been used, the pet owner can disengage the frame with the bag from coupling element 16 by pulling ends 20, 22 of frame 12 from respective passages 32. Applying an external force to frame 12, an owner may easily displace frame 12 to the folded state in which bag 14 is closed.

If connecting element 16 is fixed to frame 12, handle 18 may be detachably coupled to connecting element 16. As illustrated in FIG. 8, handle 18 and connecting element 16 can threadedly engage one another. FIG. 9 illustrates handle 18 having generally a frustoconically shaped end 34 wedged into an opening which is formed on connecting element 16.

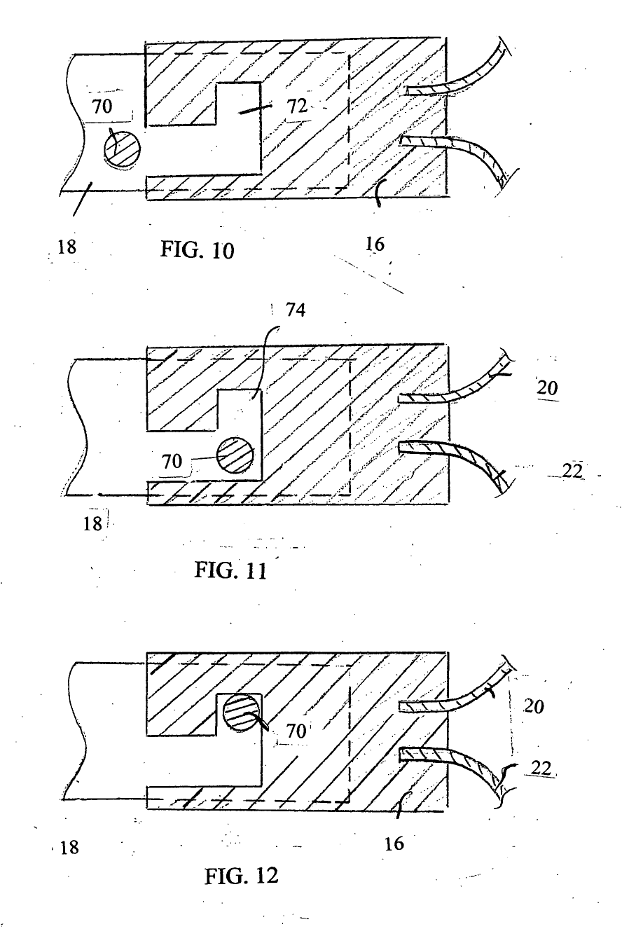

Alternatively, connecting element 16 and handle 18 may have a bayonet type connection as illustrated in FIGS. 10-12. The handle 18 is configured to be initially inserted into the hollow end of connecting element 16, as shown in FIG. 10. Subsequently, handle 18 and connecting element 16 are rotatably displaced relative to one another so that a pin 70 is moved along an L-shaped channel 74 formed in connecting element 16 from an intermediary position shown in FIG. 11 to a locking position of FIG. 12. Reversing the rotational direction of handle 18 and connecting element 16 relative to one another decouples these elements. Alternatively, L-shaped channel 74 may be formed in handle 18, whereas pin 70 may be provided on the inner surface of connecting element 16.

In a further embodiment of the invention, the upper edge of bag 14 may be provided with one or more hollow elements, such as rings 40 (FIG. 2). The ring 40 is configured to frictionally engage one of frame ends 20 and 22 in the operative position of frame 12 in which bag 14 is open. When bag 14 has been used, a pet owner may displace rings 40 towards one another, thereby closing bag 14. In addition, a rope or resilient element may be threaded through the upper portion of bag 14 so that when ring or rings 40 are disengaged from ends 20, 22 of frame 12, the ring moves along frame 12 bringing, thus, bag 14 to a closed position thereof. Also, a resilient sleeve (not shown) may surround frame 12 and be connected to the upper edge of bag 14. When frame is in the operative position, the sleeve extends along the entire frame. Upon collecting waste, the sleeve may compress and close the opening of the bag.

The specific features described herein may be used in some embodiments, but not in others, without departure from the spirit and scope of the invention as set forth. For example, the inventive device may be used as a toy, such as a butterfly catcher. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention the scope of which is defined by the following claims.

1. A portable waste collector for collecting a pet's waste comprising:
a frame displaceable between a folded position and an operative position; and
a bag coupled to the frame and configured to collect a pet's waste in the operative position of the frame.

2. The collector of claim 1, wherein the frame is disposable and made from metal or plastic or shape memory material.

3. The collector of claim 2, wherein the frame is configured to voluntarily assume the operative position and is operable to assume the folded position upon applying an external force.

4. The collector of claim 2, wherein the frame is configured to involuntarily move between the operative and folded positions.

5. The collector of claim 2, wherein the frame has a body assuming a cross-section selected from one of generally circular, polygonal and V-shaped cross-sections in the operative position of the frame.

6. The collector of claim 2, wherein the frame is operable to twirl to assume a substantially 8-shaped cross-section and folded in half to assume the folded position.

7. The collector of claim 2, wherein the frame has a pair of weakened regions configured to facilitate displacement of the frame between the folded and operative positions.

8. The collector of claim 1, further comprising a connecting element coupled to at least one of opposite ends of the frame.

9. The collector of claim 8, wherein the connecting element has two spaced passages, the passages being configured to engage respective opposite ends of the frame.

10. The collector of claim 8, wherein the opposite ends of the frame are detachably coupled to the connecting element.

11. The collector of claim 8, wherein the opposite ends of the frame are fixed to the connecting element.

12. The collector of claim 9, further comprising a handle coupled to the connecting element.

13. The collector of claims 12, wherein the handle is detachably or fixedly coupled to the connecting element.

14. The collector of claim 12, wherein the handle is telescopically configured.

15. The collector of claim 12, wherein the connecting element and handle are configured to define a bayonet connection therebetween.

16. The collector of claim 1, further comprising one or more elements threaded by the frame and coupled to the bag, the elements being configured to frictionally engage opposite ends of the frame in the operative position of the frame so as to have the bag open and to move along the frame towards one another upon applying an external force so as to close the bag.

17. The collector of claim 1, wherein the bag is made from plastic, paper or fabric and fixed to or detachably coupled to the frame.

18. A method of colleting pet's waste comprising:
transforming a frame coupled to a bag from a folded position of the frame to an operative position thereof;
positioning the frame with the bag between a ground and a pet's anus in the operative position of the frame; and
collecting the waste.

19. The method of claim 18, wherein transforming the frame from the operative position to the folded position includes twirling the frame so as to apply a generally 8-shaped cross-section to the frame, and folding the 8-shaped frame in half to the folded position.

20. The method of claim 18, further comprising;
detachably coupling the fame to a handle before the positioning of the frame,
adjusting a length of the handle before collecting the waste,
tightening the bag after collecting the waste, and
disposing the bag with the collected waste.
